(19) United States
(12) Patent Application Publication
(10) Pub. No.: US 2007/0030533 A1
(43) Pub. Date: Feb. 8, 2007

(54) Scanning method for an image acquisition apparatus

(75) Inventors: Tse-An Lin, Taoyuan (TW); Chi-Ching Huang, Hsinchu (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/495,559

(22) Filed: Jul. 31, 2006

(30) Foreign Application Priority Data
Aug. 1, 2005 (TW) 94126102

(51) Int. Cl. H04N 1/04

(52) U.S. Cl. 358/497; 358/474

(57) ABSTRACT

An image acquisition method for an image acquisition apparatus is provided. The image acquisition method includes the steps of exposing an image acquisition platform and moving an optical module from an initial position to a hiding position. The hiding position is located at an opaque area of the image acquisition platform. The opaque area is used for concealing the light emitted from the optical module. The image acquisition method of the invention prevents the light from reaching and irritating the user's eyes when the user is operating the image acquisition apparatus.

This application claims the benefit of Taiwan application Serial No. 94126102, filed Aug. 1, 2005, the subject matter of which is incorporated herein by reference.

### BACKGROUND OF THE INVENTION

1. Field of the Invention

The invention relates in general to an image acquisition method, and more particularly to an image acquisition method for an image acquisition apparatus.

2. Description of the Related Art

The scanner is a very popular apparatus for acquiring and outputting images. Referring to FIG. 1, a conventional scanner is shown. As regards the conventional scanner 10, the conventional scanner 10 comprises a scan platform 13, a scan window 14, disposed on the san platform 13, for placing a to-be-scanned document, an optical module 12 for acquiring the image of the document, and a top cover 11 for covering up the scan window 14 when placed over the scan platform 13. When the top cover 11 is displaced so to uncover the scan platform 13, the light of the optical module 12 projected through a scan window 14 of the scan platform 13 irritates the user's eyes. Particularly, when the scanner in use is a high-speed scanner, the luminance of the light source is intensified in order to save scan time and increase scan speed, such that when the scam platform 13 is uncovered, the light emitted by the light source causes discomfort and inconvenience to the user while exposed within the vision of the user.

### SUMMARY OF THE INVENTION

It is therefore an object of the invention to provide an image acquisition method which prevents the light from reaching and irritating the user's eyes when the user is operating the image acquisition apparatus.

The invention achieves the above-identified object by providing an image acquisition method. The image acquisition apparatus includes an image acquisition platform. The image acquisition method includes the steps of exposing the image acquisition platform and moving an optical module from an initial position to a hiding position. The hiding position is located at an opaque area of the image acquisition platform. The opaque area conceals the light emitted from a light source of the optical module.

The invention further achieves the above-identified object by providing a scanning method. The scanning apparatus includes a scan platform, a top cover and an optical module. The scan platform is positioned between the top cover and the optical module. The scanning method includes the steps of displacing the top cover to expose the scan platform, moving the optical module from an initial position to a hiding position, replacing the top cover over the scan platform, and moving the optical module from the hiding position to a start position. The hiding position is located at an opaque area of the scan platform, such that the opaque area conceals the light emitted from the optical module.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional scanner;

FIG. 2 is a flowchart of an image acquisition method according to a first embodiment of the invention;

FIG. 3A illustrates the image acquisition apparatus according to the first embodiment of the invention with a top cover disposed over a image acquisition platform and an optical module positioned at an initial position;

FIG. 3B illustrates the image acquisition apparatus according to the first embodiment of the invention with the image acquisition platform uncovered and the optical module positioned at a hiding position;

FIG. 3C illustrates the image acquisition apparatus according to the first embodiment of the invention with the top cover placed over the image acquisition platform and the optical module positioned at a start position; and

FIG. 4 illustrates an automatic document feeder (ADF) scanner according to a second embodiment of the invention with the scan platform uncovered.

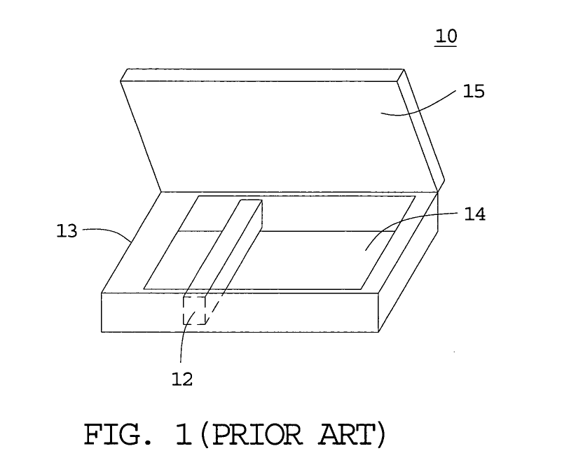

### DETAILED DESCRIPTION OF THE INVENTION

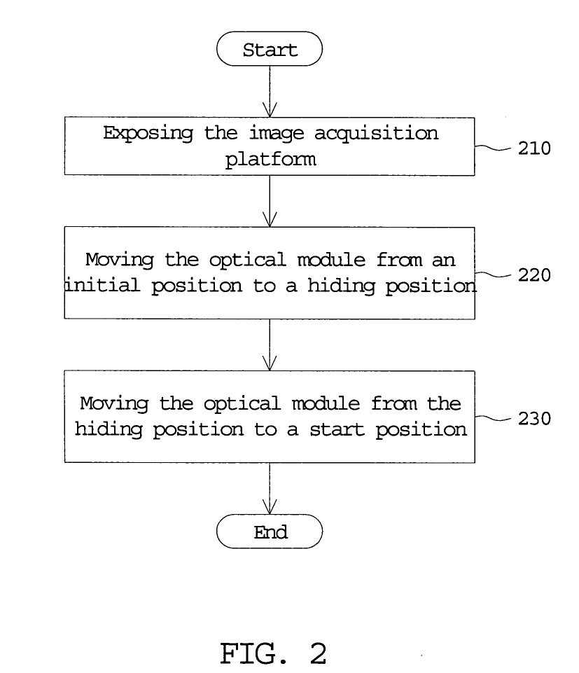

Referring to FIG. 2, a flowchart of an image acquisition method according to a first embodiment of the invention is shown. The image acquisition method begins at step 210 of exposing an image acquisition platform. Then, the method proceeds to step 220 of moving an optical module from an initial position to a hiding position. The hiding position is located at an opaque area of the image acquisition platform. Therefore, when the optical module moves to the hiding position, the opaque area exactly or partially conceals the light emitted from a light source of the optical module. Meanwhile, the user is able to place a document on the image acquisition platform without being affected by the light. Following the step 220, the method can further include a step 230 of moving the optical module from the hiding position to a start position for enabling the document disposed on the image acquisition platform to be scanned and the image of the document to be acquired.

According to the same operating principles, the image acquisition method for an image acquisition apparatus of the invention can be applied to various scanners, printers, copiers or multi-function peripherals (MFP) to prevent the light from reaching and irritating the user's eyes when the user is operating the image acquisition apparatus.

### First Embodiment

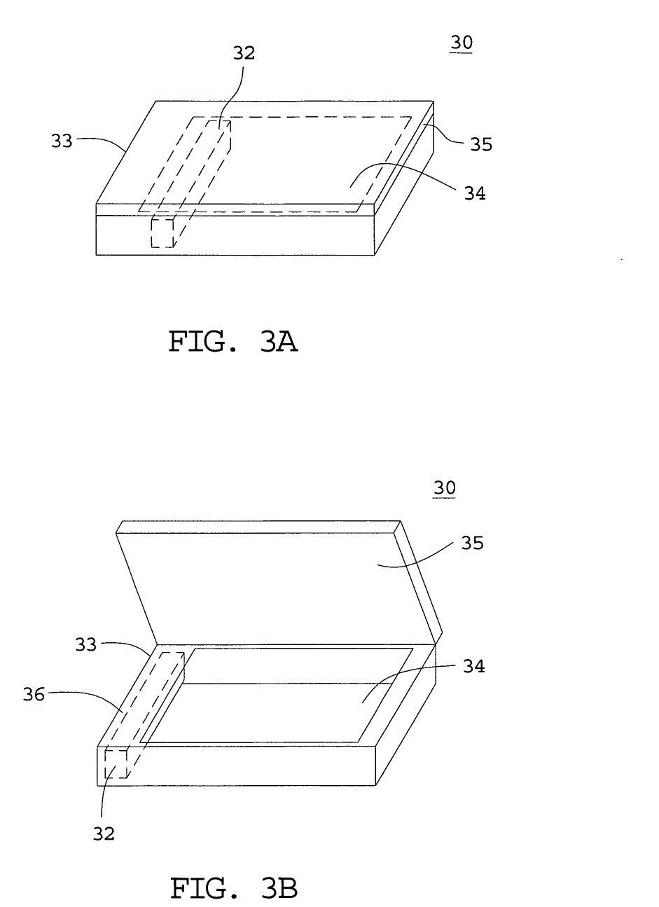

Referring to FIG. 3A, the image acquisition apparatus according to the first embodiment of the invention with a top cover disposed over an image acquisition platform and an optical module being positioned at an initial position is shown. The image acquisition apparatus 30 includes an image acquisition platform 33, a top cover 35 and an optical module 32. The image acquisition platform 33 is positioned between the top cover 35 and the optical module 32.

As shown in FIG. 3A, when the top cover 35 of the image acquisition apparatus 30 is placed over the image acquisition platform 33, the optical module 32 is positioned at an initial position. In this embodiment the initial position is located at a transparent area 34 of the image acquisition platform 33, a translucent glass, for example. However, the initial position can be any position within the compass of the image acquisition platform 33.

Referring to FIG. 3B, the image acquisition apparatus according to the first embodiment of the invention with the image acquisition platform uncovered and the optical module positioned at a hiding position is shown. The top cover 35 is displaced, such as being lifted up or rotated into an upright position, so that the image acquisition platform 33 is exposed, and the optical module 32 is driven to move from the initial position of FIG. 3A to a hiding position of FIG. 3B. As shown in FIG. 3B, the hiding position is located at an opaque area 36 of the image acquisition platform 33. The opaque area 36 conceals the light emitted from the optical module 32 and prevents the light from reaching the user directly. However, the location of the opaque area 36 is not limited thereto, but any position enabling the light emitted from the optical module 32 to be concealed will be applicable.

Referring to FIG. 3C, the image acquisition apparatus according to the first embodiment of the invention with the top cover placed over the image acquisition platform and the optical module being positioned at a start position is shown. The top cover 35 is placed on the top of the image acquisition platform 33, so that the image acquisition platform 33 is covered, and the optical module 32 is driven to move from the hiding position of FIG. 3B to the start position of FIG. 3C to be ready for scanning. As shown in FIG. 3C, the start position is located at the transparent area 34 disposed on the image acquisition platform 33. However, the start position can be any position within the compass of the image acquisition platform 33.

It is noted that despite the present embodiment is exemplified by the initial position and the start position, the invention is not limited thereto. The initial position and the start position can be the same position.

According to the image acquisition method disclosed in the first embodiment of the invention, when the top cover uncovers the image acquisition platform, the optical module is moved to a hiding position, so that the light of the light source is relatively faint to the user or even extinguished, preventing the user's eyes from being offended by the light when the user is operating the scanner.

### Second Embodiment

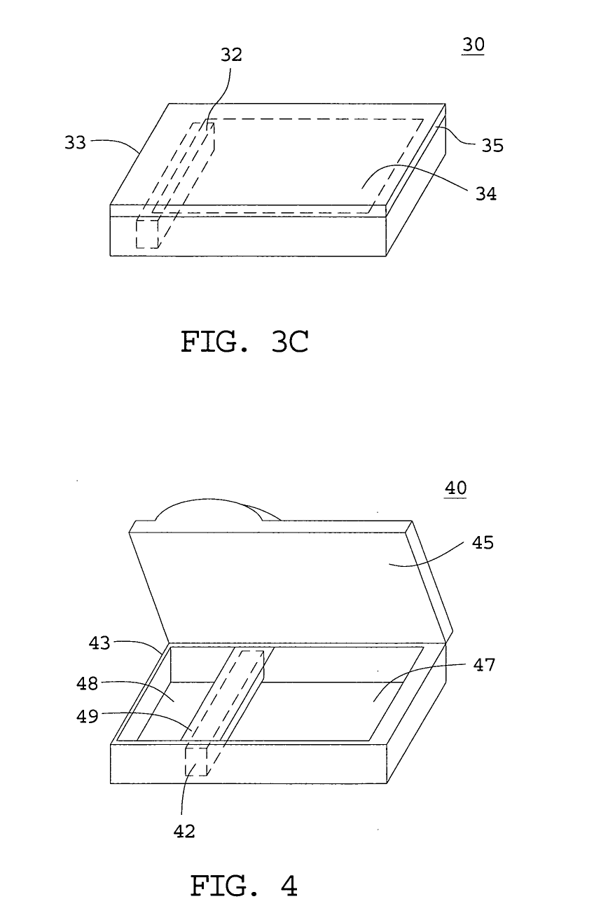

Referring to FIG. 4, an automatic document feeder (ADF) scanner according to a second embodiment of the invention with the scan platform uncovered is shown. The ADF scanner 40 includes a scan platform 43, an ADF-incorporated top cover 45 and an optical module 42. The scan platform 43 is positioned between the top cover 45 and the optical module 42.

The scan platform 43 of the ADF scanner of the second embodiment can also be divided into an opaque area and a transparent area. The procedures and operations of the scanning method of the second embodiment are similar to the first embodiment, and are not repeated here. It is noted that in the second embodiment, the ADF scanner has a calibration piece 49 disposed at the opaque area. As shown in FIG. 4, the transparent area, which is a scan glass, includes a first scan window 47 and a second scan window 48. The calibration piece 49 at the opaque area is positioned between the first scan window 47 and the second scan window 48. The calibration piece 49 is used for calibrating the optical module 45, or, in the case of a duplex scanner, is also used for calibrating an optical module installed on the top cover 45. The calibration piece 49 provides not only the function of calibrating the optical module 42 before scanning but also could provide the function of concealing the light emitted from the optical module 42. Alternatively, the calibration piece 49 alone can also achieve the function of blocking the light, so there is no need to form the opaque area specifically for the purpose of concealing the light. Hence, the space is better utilized and the volume of scanner can be further reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image acquisition method for an image acquisition apparatus, wherein the image acquisition apparatus comprises an image acquisition platform and an optical module, the method comprising:
(a) exposing the image acquisition platform; and
(b) moving the optical module from an initial position to a hiding position;
wherein, the hiding position is located at an opaque area of the image acquisition platform, and the opaque area conceals a light emitted from the optical module.

2. The method according to claim 1, wherein the image acquisition apparatus further comprises a top cover, the image acquisition platform is positioned between the top cover and the optical module, and the step (a) comprises displacing the top cover to uncover the image acquisition platform as to expose the image acquisition platform.

3. The method according to claim 1 further comprising:
(c) moving the optical module from the hiding position to a start position.

4. The method according to claim 3, wherein the step (c) comprises the step of replacing the top cover over the image acquisition platform.

5. The method according to claim 3, wherein the initial position and the start position are the same position.

6. The method according to claim 3, wherein the initial position is located at a transparent area of the image acquisition platform.

7. The method according to claim 6, wherein the start position is located at the transparent area of the image acquisition platform.

8. The method according to claim 6, wherein the transparent area is a translucent window.

9. The method according to claim 1, wherein the image acquisition apparatus is a scanner.

10. The method according to claim 9, wherein the image acquisition apparatus further comprises a calibration piece disposed at the opaque area.

11. The method according to claim 9, wherein the transparent area has a scan window.

12. The method according to claim 1, wherein the image acquisition apparatus is a copier.

13. The method according to claim 1, wherein the image acquisition apparatus is a multi-function peripheral (MFP).

14. The method according to claim 3 further comprising a step (d) of carrying a document on the image acquisition platform between the step (b) and the step (c), and further comprising a step (e) of acquiring the image of the document following the step (c).

15. A scanning method for a scanning apparatus, wherein the scanning apparatus comprises a scan platform, a top cover and an optical module, the scan platform is positioned between the top cover and the optical module, and the method comprises:
(a) displacing the top cover from the scan platform to expose the scan platform;
(b) moving the optical module from an initial position to a hiding position;
wherein the hiding position is located at an opaque area of the scan platform, and the opaque area conceals a light emitted from the optical module; and
(c) replacing the top cover over the scan platform, and moving the optical module from the hiding position to a start position.

16. The method according to claim 15, wherein the initial position and the start position are the same position.

17. The method according to claim 15, wherein the initial position is located at a scan glass of the scan platform.

18. The method according to claim 17, wherein the start position is located at the scan glass of the scan platform.

19. The method according to claim 15, wherein scanning apparatus further comprises a calibration piece disposed at the opaque area.

20. The method according to claim 15 further comprising a step (d) of carrying a document on the scan platform between the step (b) and the step (c), and further comprising a step (e) of scanning the image of the document following the step (c).
